(19) United States
(12) Patent Application Publication
(10) Pub. No.: US 2014/0309965 A1
(43) Pub. Date: Oct. 16, 2014

(54) Cooling Fan Having a Axial-Air-Gap Motor and a Method for Determining the Dimensional Proportion of the Motor

(71) Applicant: SUNONWEALTH ELECTRIC MACHINE INDUSTRY CO., LTD., KAOHSIUNG CITY (TW)

(72) Inventors: Alex Horng, KAOHSIUNG (TW); TIAN-XUAN WANG, KAOHSHIUNG (TW)

(73) Assignee: SUNONWEALTH ELECTRIC MACHINE INDUSTRY CO., LTD., KAOHSIUNG CITY (TW)

(21) Appl. No.: 14/174,935

(22) Filed: Feb. 7, 2014

(30) Foreign Application Priority Data
Apr. 10, 2013 (TW) 102112744

(51) Int. Cl. F04D 25/06; G01B 21/02

(52) U.S. Cl. CPC F04D 25/0653; G01B 21/02
USPC 702/170; 417/423.7

(57) ABSTRACT

A cooling fan having a motor is disclosed. The cooling fan includes a stator assembly and an impeller. The stator assembly includes a shaft-coupling portion and a coil unit. The impeller includes a hub and a magnetic element. An axial air gap is formed between the magnetic element and the coil unit. A height between a bottom face of the shaft-coupling portion and a top face of the hub is from 1.5 mm to 3.5 mm. The coil unit has a first maximum width, and the hub has a second maximum width. A ratio of the first maximum width to the second maximum width is from 0.7 to 1.3. A method for determining the dimensional proportion of the motor includes selecting a ratio of a first maximum width to a second maximum width as 0.7 to 1.3, and determining the values of the first and second maximum widths.

### BACKGROUND OF THE INVENTION

1. Field of the Invention

The present invention generally relates to a cooling fan and a method for determining the dimensional proportion of the motor of the cooling fan and, more particularly, to a slim cooling fan that has a reduced thickness and is equipped with an axial-air-gap motor, as well as a method for determining the dimensional proportion of the motor.

2. Description of the Related Art

In recent years, since the modern electronic products are miniaturized and have high performances, electronic elements inside the electronic product are liable to generate a large amount of heat during the operation of the electronic product. As a result, the heat of the electronic product cannot be expelled smoothly, especially in the small interior space of the electronic product. Disadvantageously, the performance of the electronic product is not stable or is even deteriorated, affecting the reliability of the electronic product. Thus, the heat dissipation has become an important issue when designing any electronic product.

Generally, a cooling fan is used in an electronic product for cooling purposes. The cooling fan operates to drive the air to flow, so that the heat in the electronic product can be expelled. Furthermore, a slim cooling fan is often used in a compact electronic product. The slim fan may have a height of, for example, 1.5 mm to 3.5 mm measured from the bottom face of the shaft-coupling portion of the fan frame to the top face of the hub of the impeller. Furthermore, the shaft of the slim fan has a larger length than that of the bearing, so that a gap is presented between the impeller and the stator of the fan. In this regard, the axial or radial air gap is about 0.1 mm to 1 mm.

Conventionally, the dimensions of the motor and the fan frame are determined according to the designers' experiences or the trial and error method. After the dimensions of the motor and the fan frame are determined, the motor is installed in the fan frame to test the performance of the fan. If the performance of the fan does not meet the required level, the dimensions of the motor and the fan frame are changed and the fan is tested again under the modified dimensions. The procedure is repeated until the performance of the fan meets the required level. Since there is no rule to be followed when determining the dimensional relation between the motor and the fan frame, it usually takes a large amount of time and effort to design the fan.

In light of this problem, a fan is disclosed by China Patent No. 101113737 entitled “FAN AND A METHOD FOR DETERMINING THE MOTOR SIZE OF THE FAN”, as shown in FIG. 1. Fan 9 includes a fan frame 91, an impeller 92 and a motor 93. Impeller 92 is installed in fan frame 91. Motor 93 includes a rotor assembly 931 and a stator assembly 932. Stator assembly 932 is able to drive rotor assembly 931 to rotate, thereby driving impeller 92 to rotate. As such, the rotating impeller 92 drives air to flow. Assume stator assembly 932 has a diameter (X) and fan frame 91 has a width (Y), the relation between (X) and (Y) is defined as:

Y=13.25 X^{1.4}±5%.

Furthermore, the ratio of (X) to (Y) is from 0.25 to 0.5. Based on this, the designer is able to correctly determine the dimensions of the fan frame and the motor, shortening the length of time in designing the fan and ensuring the performance of the fan.

However, the above formula is applicable only when the thickness of the fan is equal to or larger than 38 mm and the width (Y) of fan frame 91 is between 4 cm to 12 cm. In other words, the above formula is not applicable to the slim fan whose height is between 1.5 mm to 3.5 mm mentioned above. Although the width (Y) of fan frame 91 is one of the variables in the above formula, the configuration of fan frame 91 cannot be confirmed by the width (Y) of fan frame 91 alone. Thus, the above formula does not necessarily help in producing a fan with adequate performance. Moreover, since fan 9 has a radial air gap between rotor assembly 931 and stator assembly 932, it cannot be assured that the above formula is also applicable to a motor having an axial air gap.

### SUMMARY OF THE INVENTION

It is therefore the objective of this invention to provide a slim cooling fan equipped with a motor having an axial air gap wherein the fan structure is designed with a preferred dimensional proportion to ensure that the fan can be driven by a proper current to output a proper amount of air with proper air pressure. Thus, the performance of the fan is improved.

It is another objective of this invention to provide a method for determining the dimensional proportion of the motor of the cooling fan. Based on the method, the cooling fan can be driven by a proper current to output a proper amount of air with proper air pressure. Thus, the performance of the fan is improved.

In a preferred embodiment, a cooling fan having an axial-air-gap motor is disclosed. The cooling fan comprises a fan frame, a stator assembly and an impeller. The stator assembly includes a shaft-coupling portion, a base plate and a coil unit. The impeller includes a hub, a plurality of blades and a magnetic element. The hub is rotatably coupled with the shaft-coupling portion of the stator assembly. The plurality of blades is annularly arranged on an outer periphery of the hub. The magnetic element is arranged on an inner periphery of the hub and has a face facing the coil unit of the stator assembly. An axial air gap is formed between the magnetic element and the coil unit. There is a height between a bottom face of the shaft-coupling portion and a top face of the hub of the impeller along an axial direction. The height is from 1.5 mm to 3.5 mm. The coil unit of the stator assembly has a first maximum width (A) in a radial direction, and the hub of the impeller has a second maximum width (B) in the radial direction. A ratio of the first maximum width (A) to the second maximum width (B) is from 0.7 to 1.3.

In a preferred form shown, the ratio is between 0.85 and 1.15.

In the preferred form shown, the shaft-coupling portion is coupled with the fan frame, the base plate is fitted around the shaft-coupling portion, and the coil unit is arranged on the base plate.

In another embodiment of the invention, a method for determining the dimensional proportion of a motor of a cooling fan having an axial air gap is disclosed. The method selects a ratio of a first maximum width (A) of the motor to a second maximum width (B) of the motor as 0.7 to 1.3. The first maximum width (A) is a maximum width of a coil unit of a stator assembly of the motor along a radial direction, and the second maximum width (B) is a maximum width of a hub of an impeller of the motor along the radial direction. The method determines the value of one of the first maximum width (A) and the second maximum width (B), and determines the value of the other one of the first maximum width (A) and the second maximum width (B) based on the range of the ratio (A/B) and the previously determined value. There is a height between a bottom face of a shaft-coupling portion of the stator assembly and a top face of the hub of the impeller in the axial direction. The height is between 1.5 mm and 3.5 mm.

In a preferred form shown, the range of the ratio (A/B) of the first maximum width (A) to the second maximum width (B) is 0.85 to 1.15.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a conventional fan.

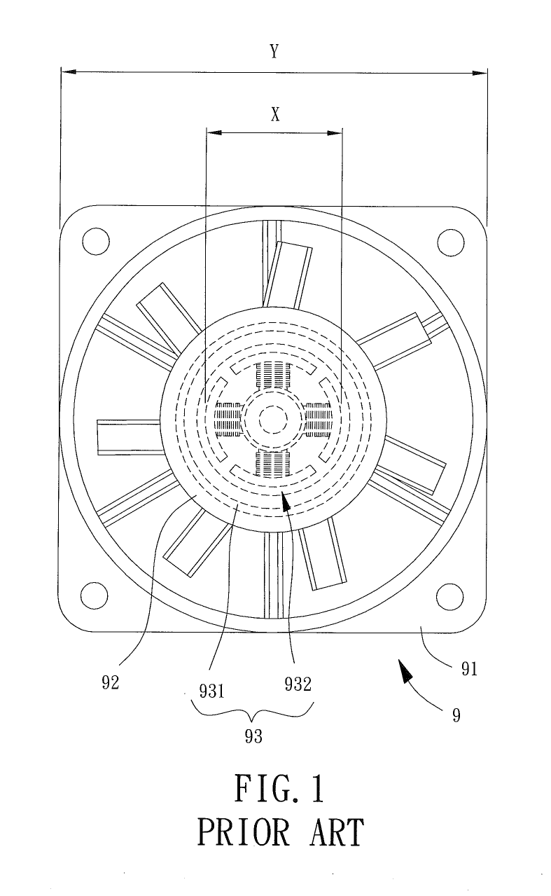

FIG. 2 is a cross-sectional view of a cooling fan according to a first embodiment of the invention.

FIG. 3 is a top view of the cooling fan of the first embodiment of the invention.

FIG. 4 shows the variation of a driving current of the cooling fan under different ratios (A/B) with a height (H) of the cooling fan ranging from 1.5 mm to 3.5 mm.

FIG. 5 is a cross-sectional view of a cooling fan according to a second embodiment of the invention.

FIG. 6 is a top view of the cooling fan of the second embodiment of the invention.

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

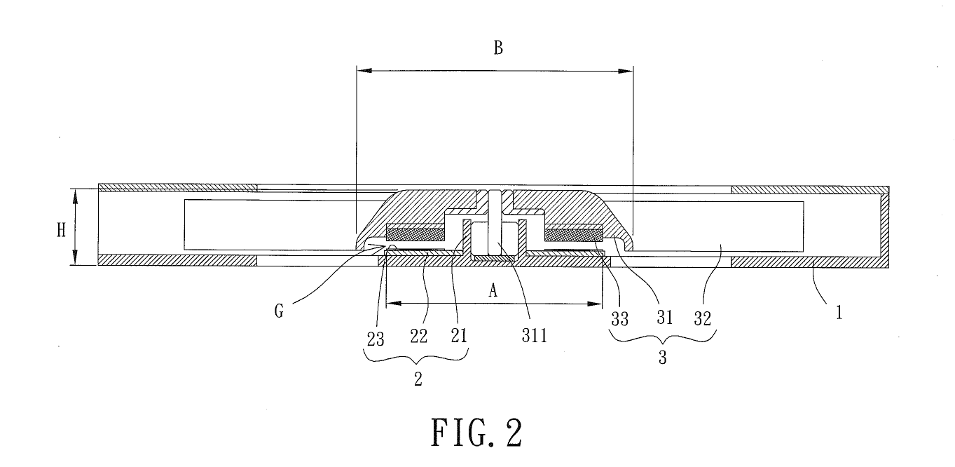

FIG. 2 shows a slim cooling fan having an axial air gap according to a first embodiment of the invention. The fan is comprised of a fan frame 1, a stator assembly 2 and an impeller 3. Stator assembly 2 is installed in fan frame 1. Impeller 3 is rotatably coupled with stator assembly 2 such that stator assembly 2 is able to drive impeller 3 to rotate. The fan may be an axial fan or a blower fan. In the embodiment, the fan is implemented as a blower fan, but is not limited thereto.

In FIG. 2, fan frame 1 is of any hollow frame where air is able to flow in and out of the frame. Stator assembly 2 includes a shaft-coupling portion 21, a base plate 22 and a coil unit 23. Shaft-coupling portion 21 may be integrally formed with fan frame 1. Alternatively, shaft-coupling portion 21 may also be affixed to or removed from fan frame 1. Base plate 22 is fitted around shaft-coupling portion 21 and is electrically connected to a driving circuit (not shown) which is used to drive impeller 3 to rotate. Coil unit 23 may be arranged on base plate 22 by ways of printing or electroforming, so that stator assembly 2 has a flat form. Base plate 22 may be a circuit board on which the driving circuit is mounted. In another embodiment, the driving circuit is arranged outside of the fan to reduce the height of the fan.

Impeller 3 includes a hub 31, a plurality of blades 32 and a magnetic element 33. Hub 31 is rotatably coupled with stator assembly 2. The plurality of blades 32 and the magnetic element 33 are coupled with hub 31. In the embodiment, hub 31 comprises a shaft 311. Hub 31 can be rotatably coupled with shaft-coupling portion 21 of stator assembly 2 via shaft 311. The plurality of blades 32 is annularly arranged on an outer periphery of hub 31. Specifically, the plurality of blades 32 may be integrally formed with hub 31. Alternatively, the plurality of blades 32 may also be affixed to or removed from hub 31. Magnetic element 33 is arranged on an inner periphery of hub 31. Stator assembly 2 is coupled with an inner periphery of hub 31 and faces coil unit 23 of stator assembly 2. An axial air gap (G) is presented between magnetic element 33 and coil unit 23.

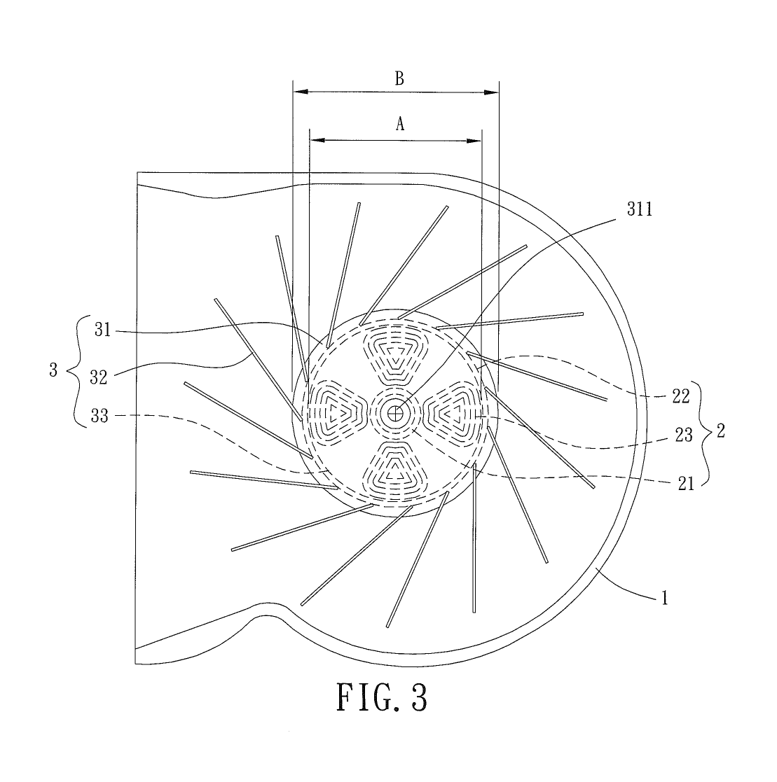

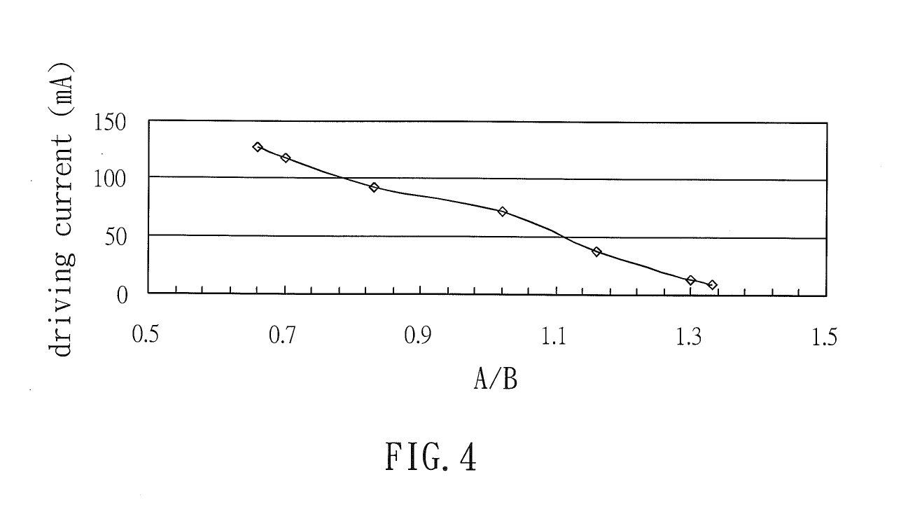

Referring to FIGS. 2 and 3, in the axial direction of the fan, the bottom face of shaft-coupling portion 21 is spaced from the top face of hub 31 of impeller 3 at a height (H). Height (H) is from 1.5 mm to 3.5 mm. In a radial direction of the fan, coil unit 23 of stator assembly 2 has a first maximum width (A), and hub 31 of impeller 3 has a second maximum width (B). There is a ratio of first maximum width (A) to second maximum width (B). FIG. 4 depicts the variation of the driving current under different ratios (A/B) with the height (H) ranging from 1.5 mm to 3.5 mm. It can be recognized from FIG. 4 that when the ratio (A/B) is from 0.7 to 1.3 the driving current of the fan will have a proper magnitude. As a result, the fan is able to output a proper amount of air with proper air pressure. Since the driving current has a proper magnitude, no extra energy is wasted. In addition, since impeller 3 has a proper size in this case, impeller 3 will not hinder the air from smoothly flowing in and out of the fan, as opposed to another case where the airflow will be hindered by impeller 3 when impeller 3 has a size that is larger than the required size. Also, since impeller 3 has a proper size in this case, the slim cooling fan is able to output a sufficient amount of air with proper air pressure, as opposed to another case where the slim cooling fan will output an insufficient amount of air when impeller 3 has a size that is smaller than the required size. In other words, the slim cooling fan that meets the ratio (A/B) of 0.7 to 1.3 has an improved performance. Furthermore, since the fan achieves a best balance between the driving current and the air capacity/air pressure when the ratio (A/B) is between 0.85 and 1.15, the slim cooling fan has a further improved performance in this range.

Based on this, the invention provides a method for determining the dimensional proportion of the motor of the slim cooling fan that has an axial air gap. In the first step, the method selects the ratio of a first maximum width (A) of a motor to a second maximum width (B) of the motor as 0.7 to 1.3. First maximum width (A) is the maximum width of coil unit 23 of stator assembly 2 in the radial direction, and second maximum width (B) is the maximum width of hub 31 of impeller 3 in the radial direction of the fan. In the second step, the method determines the value of one of the first maximum width (A) and the second maximum width (B). In the third step, the method determines the value of the other one of the first maximum width (A) and the second maximum width (B) based on the selected ratio (A/B) of 0.7 to 1.3 as well as the determined value obtained in the second step. The height (H) is between 1.5 mm and 3.5 mm. In this manner, the proper dimensional proportion of the motor can be quickly and correctly determined. Advantageously, the slim cooling fan can be driven by a proper current to output a proper amount of air with proper air pressure when equipped with the motor, achieving an improved cooling effect.

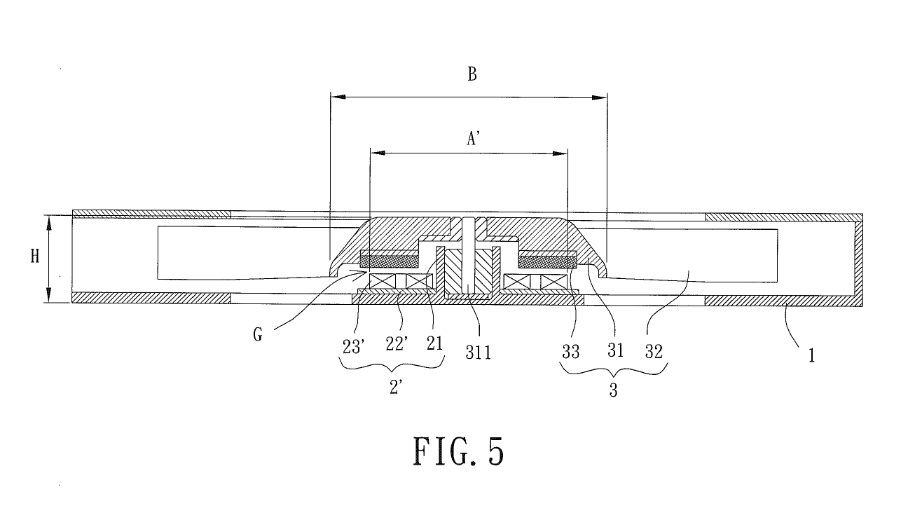

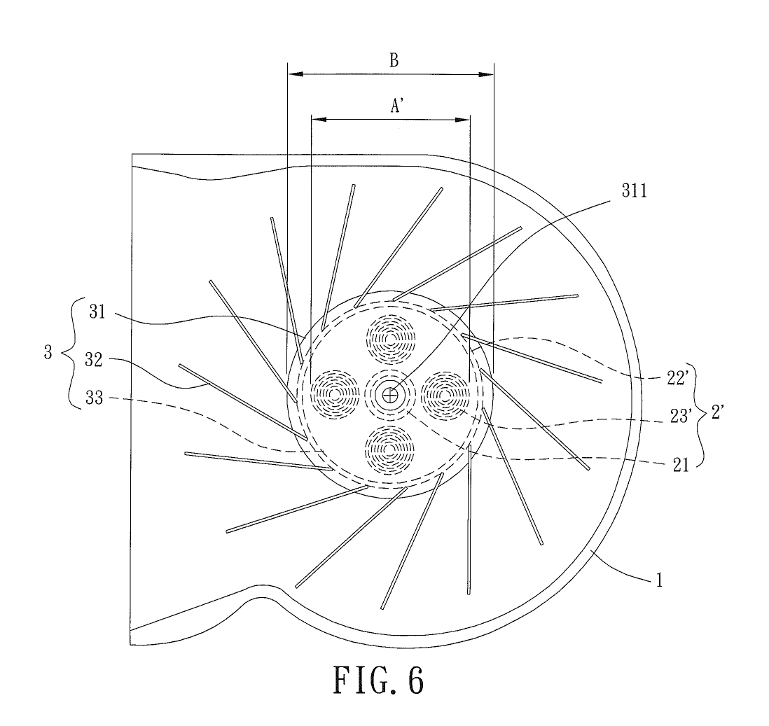

FIGS. 5 and 6 show a slim cooling fan having an axial air gap according to a second embodiment of the invention. The slim cooling fan in the second embodiment is substantially the same as that in the first embodiment. The second embodiment differs from the first embodiment in that coil unit 23′ of stator assembly 2′ is not arranged on base plate 22′ by ways of printing or electroforming. Instead, coil unit 23′ is in the form of a plurality of windings arranged on base plate 22′. Each winding can be formed with or without a core.

Similar to the slim cooling fan described above, coil unit 23′ of stator assembly 2′ has a first maximum width (A′), and hub 31 of impeller 3 has a second maximum width (B). There is a ratio of first maximum width (A′) to second maximum width (B). When the ratio (A′/B) is from 0.7 to 1.3, the slim cooling fan can be driven by a proper current to output a proper amount of air with proper air pressure, attaining an improved performance. Moreover, when the ratio (A′/B) is between 0.85 and 1.15, the slim cooling fan is able to achieve a best balance between the driving current and the air capacity/air pressure, attaining a further improved performance.

In conclusion, the motor of the slim cooling fan is designed with a preferred dimensional proportion to ensure that the fan is able to output a proper amount of air with proper air pressure, attaining an improved performance of the fan.

In addition, the proposed method is able to quickly and correctly determine the proper dimensional proportion of the motor of the slim cooling fan, ensuring that the slim cooling fan is able to output a proper amount of air with proper air pressure. Thus, improved performance of the fan is attained.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A cooling fan having an axial-air-gap motor, comprising:
a fan frame;
a stator assembly having a shaft-coupling portion, a base plate and a coil unit; and
an impeller having a hub, a plurality of blades and a magnetic element, wherein the hub is rotatably coupled with the shaft-coupling portion of the stator assembly, wherein the plurality of blades is annularly arranged on an outer periphery of the hub, wherein the magnetic element is arranged on an inner periphery of the hub and has a face facing the coil unit of the stator assembly, and wherein an axial air gap is formed between the magnetic element and the coil unit;
wherein there is a height between a bottom face of the shaft-coupling portion and a top face of the hub of the impeller along an axial direction, wherein the height is from 1.5 mm to 3.5 mm, wherein the coil unit of the stator assembly has a first maximum width (A) in a radial direction, wherein the hub of the impeller has a second maximum width (B) in the radial direction, and wherein a ratio of the first maximum width (A) to the second maximum width (B) is from 0.7 to 1.3.

2. The cooling fan having the axial-air-gap motor as claimed in claim 1, wherein the ratio is between 0.85 and 1.15.

3. The cooling fan having the axial-air-gap motor as claimed in claim 1, wherein the shaft-coupling portion is coupled with the fan frame, wherein the base plate is fitted around the shaft-coupling portion, and wherein the coil unit is arranged on the base plate.

4. A method for determining the dimensional proportion of a motor of a cooling fan that has an axial air gap, comprising:
selecting a ratio of a first maximum width (A) of the motor to a second maximum width (B) of the motor as 0.7 to 1.3, wherein the first maximum width (A) is a maximum width of a coil unit of a stator assembly of the motor along a radial direction, and wherein the second maximum width (B) is a maximum width of a hub of an impeller of the motor along the radial direction;
determining the value of one of the first maximum width (A) and the second maximum width (B); and
determining the value of the other one of the first maximum width (A) and the second maximum width (B) based on the range of the ratio (A/B) and the previously determined value, wherein there is a height between a bottom face of a shaft-coupling portion of the stator assembly and a top face of the hub of the impeller in the axial direction, and wherein the height is between 1.5 mm and 3.5 mm.

5. The method for determining the dimensional proportion of the motor of the cooling fan as claimed in claim 4, wherein the range of the ratio (A/B) of the first maximum width (A) to the second maximum width (B) is 0.85 to 1.15.
